(19) United States
(12) Patent Application Publication
(10) Pub. No.: US 2025/0379898 A1
(43) Pub. Date: Dec. 11, 2025

(54) SYSTEMS AND METHODS FOR BRIDGED AUDIO CONFERENCING WITH SELECTIVE AUDIO STREAM CONFIGURATION

(71) Applicant: IPC Systems, Inc., New York, NY (US)

(72) Inventors: Robert Coole, Bushey (GB); Toby Anthony James Walsh, Petts Wood (GB)

(21) Appl. No.: 19/227,120

(22) Filed: Jun. 3, 2025

Related U.S. Application Data
(60) Provisional application No. 63/656,397, filed on Jun. 5, 2024.

(51) Int. Cl. H04L 65/1104; H04L 65/1069; H04L 65/403; H04L 65/80

(52) U.S. Cl. CPC H04L 65/1104; H04L 65/1069; H04L 65/403; H04L 65/80

(57) ABSTRACT

Systems and methods are disclosed for bridging SIP calls in conference environments that include both SIP and TDM legs. A request to bridge a SIP call from a specific conference number is received, and the system configures caller and called IDs for the bridged call. Audio is selectively sourced from all primary SIP legs excluding dynamic legs, all sequence SIP legs excluding dynamic legs, or a mixed audio stream including dynamic legs. The bridged call is established using either a default SIP trunk configured in a node or a unique SIP trunk if no default is set. The system supports mixed-protocol integration, continuous connection attempts, automatic reconnection, RTP/RTCP timeout protection, and high availability with node failover. Additional features include codec configuration via SDP, support for multiple simultaneous bridged calls, on-demand call drop, and a user portal for managing bridging services. Bridging does not disrupt ongoing conferences or original configurations.

### CROSS REFERENCE TO RELATED APPLICATIONS

This application claims priority to and the benefit of U.S. Provisional Patent Application No. 63/656,397, filed Jun. 5, 2024, which is hereby incorporated by reference in its entirety.

### TECHNICAL FIELD

Example embodiments described herein relate to audio bridging systems and methods, and more particularly to systems and methods for bridging Session Initiation Protocol (SIP) calls in conference environments that handle both SIP and Time-Division Multiplexing (TDM) communications.

### BACKGROUND

Session Initiation Protocol (SIP) is a widely adopted communication protocol used for initiating, modifying, and terminating real-time sessions involving video, voice, messaging, and other multimedia applications over internet protocol (IP) networks. SIP can be utilized in both enterprise and consumer communication systems for setting up and controlling voice and video calls in Voice over IP (VOIP) systems, as well as for instant messaging and presence information applications.

In traditional telecommunications systems, Time-Division Multiplexing (TDM) has been used as a method of transmitting multiple signals or streams of data over a single communication channel by dividing the channel into multiple time slots. In TDM systems, each signal or data stream is assigned a specific time slot to transmit its data, with these time slots being interleaved to form a single composite signal for transmission.

As modern communication systems evolve, there is an increasing need to bridge between different types of communication protocols and systems, particularly in conference environments where both SIP and TDM communications may be present. Current systems face challenges in managing mixed audio streams, handling dynamic legs, and maintaining reliable connections across different communication protocols. Additionally, existing solutions often struggle with providing flexible audio selection options and maintaining service continuity in high-availability environments.

Several technical challenges need to be overcome to achieve effective audio bridging in these mixed protocol environments. One significant challenge is the simultaneous management of SIP and TDM communications within the same conference environment, for example when making TDM audio available in mixed audio bridges while maintaining SIP-only audio in endpoint bridged calls.

Another technical challenge in bridged call systems is maintaining reliable connections, particularly in scenarios involving failed or dropped calls. Existing systems often lack effective mechanisms for continuously attempting reconnections within defined time windows or for automatically reestablishing communication sessions. Additionally, conventional solutions may be vulnerable to disconnections caused by protocol timeouts and may fail to ensure codec compatibility across diverse audio formats. Accordingly, there remains a need for improved connection management techniques that support automatic recovery and seamless interoperability across heterogeneous communication environments.

High-availability communication environments also face a significant technical challenge in maintaining service continuity during node failures. Existing systems often require complex and error-prone failover mechanisms to transition bridged calls from a failed primary node to a secondary node without disrupting active sessions. In many cases, current approaches lack the ability to automatically reinitiate bridged calls based on predefined connection conditions while preserving the integrity of ongoing conferences and system configurations. Accordingly, there is a need for robust and intelligent failover strategies that ensure seamless continuity of service with minimal disruption to active call sessions.

### SUMMARY

The example embodiments described herein address technical challenges associated with bridging SIP calls in conference environments that include both SIP and TDM communications. These embodiments provide systems and methods for dynamically managing audio configurations, to provide more reliable connections, and supporting high-availability operations without disrupting existing calls or configurations.

The embodiments enable flexible and selective audio stream handling, allowing audio to be chosen from all primary SIP legs (excluding dynamic legs), all sequence SIP legs (excluding dynamic legs), or a mixed audio configuration that includes dynamic legs. The bridged call may be established using a default SIP trunk configured in a node or by selecting a unique SIP trunk if no default is available.

For conferences that include TDM legs, the system allows TDM audio to be included in the mixed audio of the bridged call while preserving SIP-only audio at the A and B ends of the bridged calls. This approach supports seamless integration of mixed-protocol communications while maintaining control over the audio presented in each call leg.

The system also implements continuous connection attempts and automatic reconnection mechanisms to enhance call reliability. Bridged calls automatically reconnect in the event of disconnection and are protected from RTP/RTCP timeouts to avoid premature termination.

In high-availability environments, the system provides service continuity by enabling bridged calls to fail over to secondary nodes if a primary node fails. Bridged calls can also be dropped independently on demand, allowing granular call control.

Additional features include support for multiple codecs through SDP configuration, availability of bridging functions across all production nodes, and the ability to initiate multiple bridged calls simultaneously for a single conference. Importantly, these capabilities are implemented in a way that permits the original conference configuration and ongoing calls remain unaffected.

In some embodiment, the system provides a portal interface that enables users and customers to enable or disable bridged call services on demand. Private wires can be configured either for permanent bridging in a required format or for on-demand start/stop triggering through the portal.

In an example embodiment, a method is provided for bridging a SIP call from a specific conference number within an audio bridge system. This method involves receiving a request to initiate a bridged SIP call tied to a particular conference number. Upon receipt of the request, the system configures the caller ID and called ID for the bridged call. The audio source for the bridged call is then selected from one of the following options: all primary SIP legs excluding dynamic legs, all sequence SIP legs excluding dynamic legs, or a mixed audio stream that includes all primary and sequence SIP legs, including dynamic legs. The bridged call is then established either by using a default SIP trunk configured in a node, or by selecting a unique SIP trunk in the absence of a default configuration.

In certain embodiments, where the conference includes SIP legs, the method further includes integrating SIP audio into the mixed audio of the bridged call and ensuring that only the audio from the SIP legs is included at both the A-end and B-end of the bridged calls. In scenarios where the conference includes TDM legs, TDM audio may be incorporated into the mixed audio of the bridged call, while still limiting the audio at the A-end and B-end of the bridged calls to only that of the SIP legs.

The method also supports the capability to trigger bridged calls simultaneously for the same conference. However, such bridged calls are only initiated if there is at least one connected participant leg, and the type of the bridged call is determined based on the type of the connected leg. If the call fails to establish within a specified time period, the system will continuously attempt to connect. In case of disconnection, the bridged call automatically reconnects. Additionally, bridged calls are not terminated due to RTP/RTCP timeout.

In high availability configurations, if the primary node fails, bridged calls are established in the secondary nodes of the pair. The system also allows bridged calls to be dropped separately on demand. The Session Description Protocol (SDP) of a bridged call includes all codecs that are configured in the bridge from which the call is triggered. Notably, the act of bridging a call does not interfere with ongoing conferences, other calls, or existing configurations. Furthermore, the bridged call feature is available across all nodes in production environments.

The bridge system itself includes a processor configured to carry out instructions for bridging a SIP call from a specific conference number. This involves configurable caller and called IDs and selecting the appropriate audio stream from either all primary SIP legs excluding dynamic legs, all sequence SIP legs excluding dynamic legs, or mixed audio from all primary and sequence SIP legs including dynamic legs. The system includes a memory module that stores these instructions and associated data, and a network interface that is responsible for receiving the bridging request and establishing the bridged call using either a default SIP trunk configured in a node or selecting a unique SIP trunk if none is set as default.

Additionally, a non-transitory computer-readable storage medium is disclosed. This medium stores instructions that, when executed by a processor, cause the processor to perform the method of bridging a SIP call from a specific conference number. This includes receiving the bridging request, configuring the caller and called IDs, selecting the audio source as described above, and establishing the bridged call through the appropriate SIP trunk based on the configuration of the node.

### BRIEF DESCRIPTION OF THE DRAWINGS

The features and advantages of the example embodiments of the invention presented herein will become more apparent from the detailed description set forth below when taken in conjunction with the following drawings.

FIG. 1 illustrates an architecture and call flow for an audio bridge system, according to an example embodiment.

FIG. 2 is a flowchart depicting a procedure for bridging SIP calls, according to an example embodiment.

FIG. 3 illustrates an API request flow diagram for managing bridged call services, according to an example embodiment.

FIG. 4 discloses a computing environment in which aspects of the present disclosure may be implemented.

FIG. 5 illustrates example start service line (bridged calls) voice commands, according to an example embodiment.

### DETAILED DESCRIPTION

The present disclosure relates to systems and methods for dynamically bridging Session Initiation Protocol (SIP) calls from specific conference numbers in an audio bridge system. In particular, the system enables flexible, on-demand SIP call bridging with configurable parameters and robust fault-tolerant operation across high-availability (HA) nodes.

A trading communications system represents a specialized switching infrastructure tailored to grant a relatively small number of users access to a vast array of external lines. This system offers an array of advanced communication functionalities, including hoot-n-holler, push-to-talk, intercom, video capabilities, large-scale conferencing, and private wires. Private wires refer to dedicated, point-to-point communication lines that offer reliable, low-latency connectivity between counterparties, often used for high-priority or mission-critical conversations in trading environments. A turret device, also referred to simply as a “turret,” serves as the component allowing a user to manage multiple dedicated and active communication lines, including private wires, facilitating simultaneous communications with multiple parties. Turret devices may incorporate dual handsets, multichannel speaker modules, and support several communication lines.

A trading turret device can be implemented either in dedicated hardware, termed a “hard” turret, or in software, known as a “soft” turret. A hard turret typically manifests as a phone-like desktop device equipped with multiple handsets, speakers, and buttons. Conversely, a soft turret exists as a software application that operates on a trader's desktop personal computer (PC) or mobile devices like smartphones. Control of a soft-turret application occurs through the native control interface provided by the computer, including touch screens, styluses, click wheels, or mouse and keyboard inputs. In addition to displaying a graphical representation of the turret on the PC screen, the soft-turret application may also offer voice and presence features. A soft turret can also be implemented by a combination of a PC or mobile device and connected hardware components such as one or more handsets, speakers, and buttons, providing flexibility in its configuration and usage.

Trading turret devices include many different audio input and output devices. For example, a trading turret may include a handset, speakers, and/or a headset for either capturing audio or outputting audio received from a separate device. Each of these devices are configured to connect to a communication system or turret to enable voice communication with a remote device, including communications over private wires.

Although traditionally implemented using dedicated physical circuits, private wires may also be realized as virtual connections over IP-based networks. These modern implementations can use private IP networks (such as MPLS), VPNs over the public internet, or encrypted SIP trunks to simulate the behavior of a dedicated always-on audio channel between endpoints. When implemented over the internet, private wires typically require additional measures to provide reliability, such as encryption, Quality of Service (QOS) controls, and high-availability architectures. While the underlying transport may differ from traditional private lines, the functional goal remains the same: to provide persistent, low-latency, point-to-point communication, often used in time-sensitive or mission-critical environments such as financial trading.

Two basic types of turret calls are known as “handset calls” and “speaker calls”. Handset calls behave similarly to standard telephone calls and can be used to speak to someone else or a group of people in a conference call. An audio data stream comprises both a talk path (also referred to as a transmit channel), which corresponds to an input audio data stream, and a receive path (also referred to as a receive channel), which corresponds to an output audio data stream. This arrangement essentially involves the transmission and reception of audio data, with the transmit channel serving as the pathway for input data and the receive channel handling the output data stream. Speaker calls in a communication device have the receive channel communicatively coupled to a speaker. Speaker Calls involve a push-to-talk (PTT) button which communicatively couples a microphone in a communication device to the transmit channel of a speaker call. In the case where a communication device is connected to multiple speaker calls, there are multiple push-to-talk buttons that can be selected at the same time to connect the microphone of the communication device to the transmit channels of multiple speaker calls.

The disclosed methods and apparatus are particularly well suited for deployment in environments that incorporate real-time audio conferencing systems—such as hoot-and-holler networks—and transcription services as components. In relation to such components, as used herein, the terms “bridged call” and “service line,” in an example embodiment, refer to a call that is captured or transcribed within the audio bridge system.

Aspects of the embodiments are now described herein in terms of an example transcription and/or capture service for private wires that enables audio bridging capabilities in conference environments. This description is not intended to limit the application of the example embodiments presented herein. In fact, after reading the following description, it will be apparent to one skilled in the relevant art(s) how to implement the following example embodiments in alternative embodiments (e.g., involving other types of services such as real-time language translation, voice biometrics, or compliance monitoring).

In some embodiment, the system supports at least two distinct configuration methods for private wires: permanent bridging (e.g., in a required format) and on-demand configuration through the portal interface for start/stop triggering.

### Bridging Architecture

In an example embodiment, an audio bridge system includes multiple nodes capable of establishing bridged SIP calls from ongoing conferences. Each node can interface with SIP trunks, conference servers. In some embodiments, each node can also include TDM endpoints. In an example implementation, bridging operations are performed based on explicit instructions received from a control portal or external application programming interface (API). The portal interface, in an example implementation, uses the following parameters for bridging operations:
1. Conference Number (e.g., formatted as HOOT conference)
2. Caller ID (e.g., formatted as Local CNXVID+UCN)
3. Called ID (e.g., formatted as Remote end CNXVID+UCN)
4. Bridge Type, specified as:
   “Primary”: A-end audio
   “Sequence”: B-end audio
   “Mixed”: Capture all conference audio (primary and sequence and by default including Dynamic legs)
5. Add/Remove service indicator.

In some embodiments, the system supports three primary types of bridged audio capture: primary SIP leg audio, sequence SIP leg audio, and mixed audio:

A “leg” refers to a single segment or endpoint of a communication connection between two parties or systems. In the context of a call or audio bridge, each participant is connected via a distinct call leg. In SIP-based systems, each participant in a bridged call is connected via an individual SIP leg, which comprises both signaling and media paths. These legs can be independently managed to support features such as call rerouting, fault tolerance, recording, and transcription. For example, in a multi-party bridged call, each party's SIP leg can be separately monitored, rerouted, or terminated without affecting the others. Primary SIP leg audio involves capturing A-end participants of the SIP session (excluding dynamic legs). Sequence SIP leg audio refers to audio from B-end participants of the session (also excluding dynamic legs). Mixed audio involves capturing audio from both primary and sequence legs, and may optionally include dynamic SIP or TDM legs. A dynamic leg refers to a call leg that is not statically provisioned, but instead established on demand—for example, when a participant is added dynamically to an ongoing conference or when a temporary path is created to support overflow, recording, or monitoring functions. These legs may be created and torn down programmatically, often without user intervention.

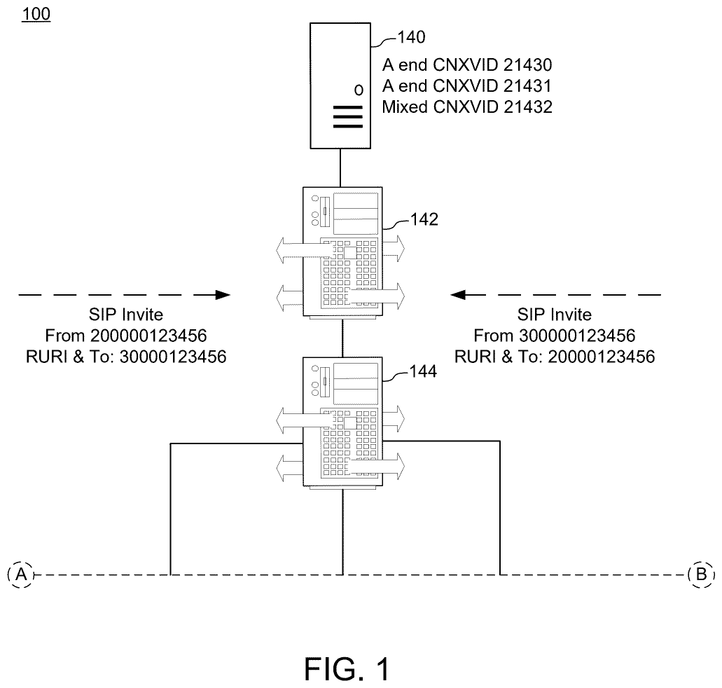

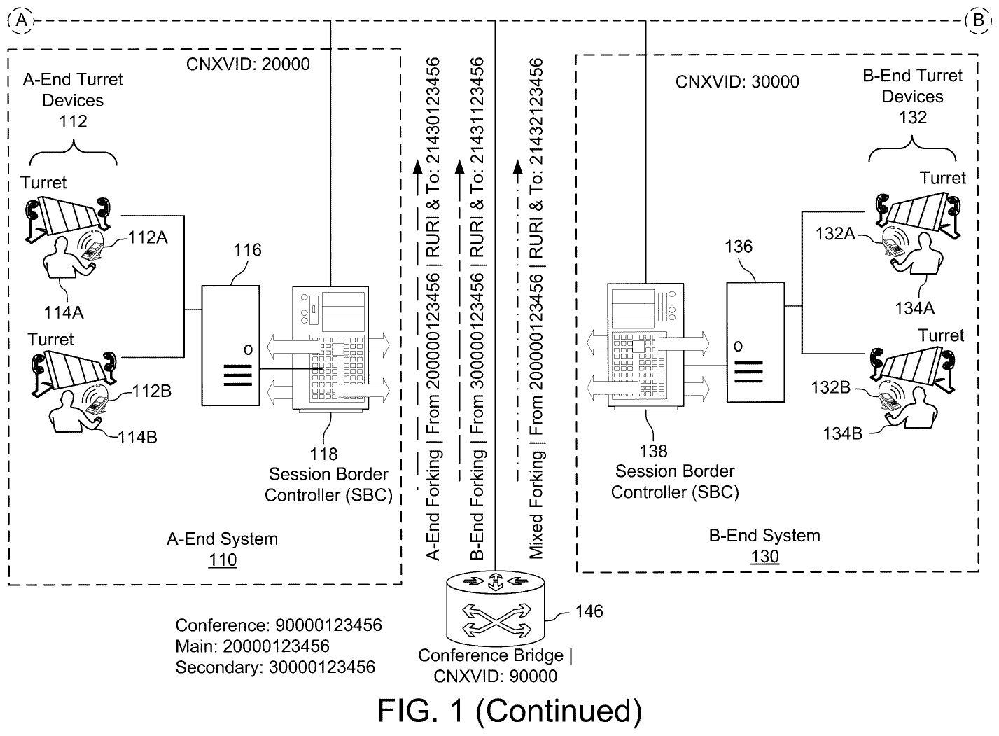

FIG. 1 illustrates an architecture and call flow for an audio bridge system 100, according to an example embodiment. In this example embodiment, the audio bridge system 100 supports transcription of SIP-based conference calls, including A-end, B-end, and mixed audio streams, according to an example embodiment.

As used herein, CNXVID stands for connection virtual ID (or connection ID). CNXVID is used in communication systems (e.g., turret or telephony systems) to uniquely identify a voice session or endpoint within a larger conferencing or call management system. In some embodiments, connection IDs are used to route SIP messages and match individual call legs or services (e.g., mixed audio or transcription fees) programmatically.

Audio bridge system 100 includes an A-end system 110 having a first connection ID (CNXVID: 20000). A-end system 110 operates to originate one leg of a conference call. As shown in FIG. 1, A-end system 110 includes a plurality of turret devices 112 (e.g., turret devices 112A and 112B), a media server 116, and a session border controller (SBC) 118. Media server 116 operates to stream, record, or mix conference audio for originating endpoints. SBC 118 is a network element used to control and secure IP communication flows. In some embodiments, SBC 118 manages SIP signaling for call setup and teardown, provides security by masking internal networks, performs NAT traversal, enforces media and signaling policies, and supports codec negotiation and transcoding when required.

In an example embodiment, A-end system 110 initiates a SIP INVITE message using a device (e.g., a turret device 112) with a caller ID of 20000123456. The INVITE originates from a system with CNXVID 20000 and a virtual ID 20000123456. The request-URI (RURI) of the INVITE specifies the destination address, and the “To” header identifies the called party. In this implementation, the INVITE is directed to a system with CNXVID 30000 and virtual ID 30000123456.

System 100 also includes a B-end system 130, associated with a second connection ID (CNXVID: 30000). B-end system 130 is responsible for terminating the other leg of the conference call. As shown in FIG. 1, B-end system 130 includes a plurality of turret devices 132 (e.g., turret devices 132A and 132B), a media server 136, and a session border controller (SBC) 138. Media server 136 operates to receive and process audio streams for terminating endpoints. SBC 138 is a network element used to control and secure IP communication flows. In some embodiments, SBC 138 manages SIP signaling for call setup and teardown, provides security by concealing internal infrastructure, performs NAT traversal, enforces media and signaling policies, and supports codec negotiation and transcoding, if required.

B-end system 130 mirrors the architecture of A-end system 110 and functions as the receiving endpoint of the conference connection. Like the A-end, it includes communication devices (e.g., turret devices 132, e.g., turret device 132A and 132B), a media server 136, and an SBC 138.

B-end system 130 initiates a SIP INVITE message using a device (e.g., turret device 132) with a caller ID of 30000123456. The INVITE originates from a system with CNXVID 30000 and a virtual ID 30000123456. The request-URI (RURI) of the INVITE specifies the destination address, and the “To” header identifies the called party. In this implementation, the INVITE is directed to a system with CNXVID 20000 and virtual ID 20000123456.

SBC 142 represents multiple instances of an SBC. SBC 142, in some embodiments, operates as the security and media traversal control point between internal systems (e.g., A-end system 110 and B-end system 130) and external services (transcription system 140 and conference bridge 146). In this example, transcription system 140 has a plurality of transcription endpoints CNXVID: 21430/21431/21432.

System 100 further includes a conference bridge 146 associated with a conference connection ID (CNXVID) of 90000. Conference bridge 146 operates to mix audio streams received from both the A-end and B-end systems (i.e., each leg of the SIP-based communication) for conferencing purposes. The conference bridge 146 supports multi-party audio communication by combining the media streams from the respective endpoints into a unified audio output.

In some embodiments, the audio bridge system 100 includes an audio stream management subsystem that implements stream selection logic to determine which audio streams to include in bridged conference calls. For calls utilizing primary-only bridging, the system employs an algorithm that identifies and selects streams associated with A-end call legs while explicitly excluding dynamic legs based on predefined criteria. Similarly, for sequence-only bridging, the system identifies and selects B-end call legs, applying filtering logic to exclude dynamic legs that do not meet the inclusion parameters. For mixed audio bridging, the system includes both primary and sequence legs as well as any dynamic legs in the audio configuration.

Referring to FIG. 1, in an example implementation, SIP addressing for conference bridge 146 is handled as follows. For the A-end leg of the conference, SIP messages are sent using a “From” address of 20000123456, with both the Request-URI (RURI) and “To” header set to 21430123456. For the B-end leg, the SIP messages use a “From” address of 30000123456, with the RURI and “To” header set to 21431123456. In addition, the system may generate a mixed audio stream, which uses a “From” address of 30000123456, with the RURI and “To” header set to 21432123456. These distinct addressing schemes facilitate the proper routing and handling of media streams for individual and mixed audio paths.

Dynamic leg exclusion, in some embodiments, is facilitated by a detection mechanism that evaluates call leg characteristics to distinguish dynamic legs—such as those associated with ad hoc participants, consultative transfers, or short-lived auxiliary paths—from persistent legs associated with primary or sequence participants. Once identified, these dynamic legs are programmatically excluded from the bridge to maintain precise control over the audio composition of the conference call and provide consistent audio presentation for each endpoint. This enables flexible yet deterministic audio stream configuration across a range of call topologies.

The stream selection logic applies a set of decision criteria that may include, for example, identifiers associated with primary legs (e.g., known caller or device IDs), indicators of sequence participation (e.g., session timing or signaling context), detection of dynamic or transient call legs, and stream priority policies. These criteria may be derived from SIP signaling metadata (such as Call-ID, From, To, or custom headers), session timing data, or system configuration rules.

To provide high availability and system resilience, the architecture incorporates failover mechanisms triggered by specific operational conditions. These may include detection of a primary node failure, loss of network connectivity to critical components, or exhaustion of computational or network resources. When a triggering event occurs, the system initiates a failover procedure designed to preserve ongoing sessions.

During failover transitions, the system maintains call continuity through a combination of session state replication, media stream handover, and configuration synchronization. Session state replication provides for the preservation of call metadata, participant state, and stream selections between nodes. Media stream handover may involve re-establishing RTP flows via re-INVITE messages or equivalent signaling to redirect media paths through the active node. Configuration synchronization allows system parameters such as bridge configuration, active participant lists, and stream priorities remain consistent across failover and recovery transitions.

Upon restoration of the primary node, the system executes recovery procedures that may include verifying the integrity of replicated session state, migrating active traffic back to the primary node where appropriate, and reconciling configuration differences accumulated during the failover interval. These recovery procedures supports a seamless transition of bridged calls between nodes, preserving the continuity of active conferences and maintaining the fidelity of stream selection and configuration parameters.

Collectively, these mechanisms-encompassing stream selection, dynamic leg filtering, failover triggering, session continuity, and post-recovery reconciliation—serve to enhance the reliability, scalability, and precision of the conferencing system while supporting a variety of flexible call handling scenarios.

As introduced above, a transcription system 140, in some embodiments, is communicatively coupled to conference bridge 146. Transcription system 140 is configured to receive mirrored or bridged audio streams for the purpose of transcription. In the illustrated embodiment, transcription system 140 receives three separate CNXVID streams corresponding to different components of the conference audio: a first CNXVID 21430 carrying A-end audio, a second CNXVID 21431 carrying B-end audio, and a third CNXVID 21432 carrying the mixed audio output. These streams allow the transcription engine to process individual participant audio as well as the combined conference content.

The turret device 112, 134 is a device used by a user 114A, 114B, 134A, 134B (individually and collectively 114, 134, respectively) that can be used as part of processes described herein. The turret device 112, 134 can include one or more aspects described elsewhere herein such as in reference to the audio bridge system 100 of FIG. 1. In the illustrated example, the turret device 112, 134 can include a turret device processor set, a turret device interface set, and a turret device memory set, among other components.

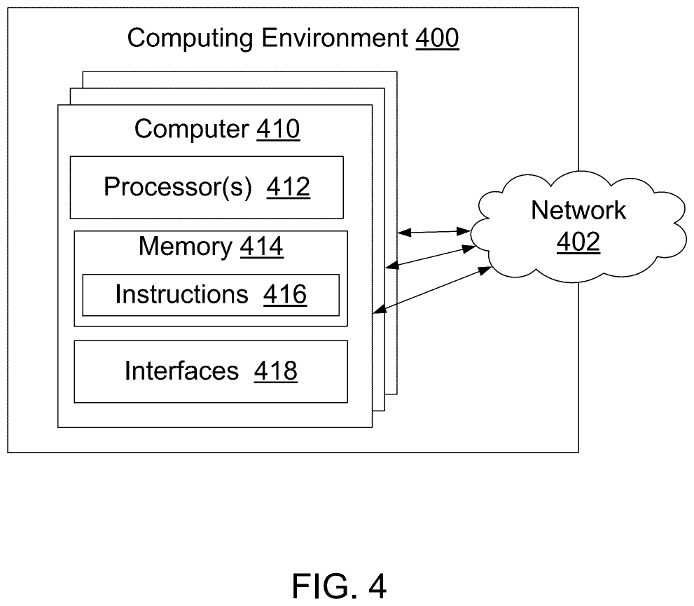

The turret device processor set is a set of one or more processors. One or more processors are components of the turret device (112, 134) that execute instructions, such as instructions that obtain data, process the data, and provide output based on the processing. The turret device processor set can include one or more aspects described below in relation to the processor set 412 of FIG. 4.

The turret device interface set is a set of one or more interfaces, which are one or more components of the turret device 112, 134 that facilitate receiving input from and providing output to something external to the turret device 112, 134. The turret device interface set can include one or more aspects described below in relation to the interface set 418 of FIG. 4.

The turret device memory set is a set of one or more memory components, which are components of the turret device 112, 134 configured to store instructions and data for later retrieval and use. The turret device memory set can include one or more aspects described below in relation to the memory 414 of FIG. 4. As illustrated, the turret device memory set stores turret device instructions. Turret device memory set also stores other turret device code.

The turret device instructions are a set of instructions that, when executed by the turret device processor set, cause the device processor set to perform an operation described herein. In examples, the turret device instructions can be those of a mobile application (e.g., that may be obtained from a mobile application store, such as the APPLE APP STORE or the GOOGLE PLAY STORE). The mobile application can provide a user interface for receiving user input from a user and acting in response thereto. The user interface can further provide output to the user. In some examples, the turret device instructions are instructions that cause a web browser of the turret device 112, 134 to render a web page associated with a process described herein. The web page may present information to the user and be configured to receive input from the user and take actions in response thereto.

The media servers 116, 136, session border controllers 118, 138, 142, application server 144, transcription system 140, and conference bridge 146 are each server devices that function as part of one or more processes described herein. In the illustrated example, each of these components includes a processor set, an interface set, and a memory set, among other components.

The processor set is a set of one or more processors that are components of the respective device (i.e., media server, session border controller, application server, transcription system, or conference bridge) that execute instructions, such as instructions that obtain data, process the data, and provide output based on the processing. The processor set can include one or more aspects described below in relation to the processor set 412 of FIG. 4.

The interface set is a set of one or more components of the respective device that facilitate receiving input from and providing output to something external to the device. The interface set can include one or more aspects described below in relation to the one or more interfaces 418 of FIG. 4.

The memory set is a collection of one or more components of the respective device configured to store instructions and data for later retrieval and use. The memory set can include one or more aspects described below in relation to the memory 414 of FIG. 4. The memory set can store device-specific instructions.

The device-specific instructions are instructions that, when executed by one or more processors of the processor set, cause the processor set to perform one or more operations described elsewhere herein.

Each of the media servers 116, 136, session border controllers 118, 138, 142, application server 144, transcription system 140, and conference bridge 146 has its own processor set, memory set, and interface set. The application server 144 manages application-level signaling and call logic for the audio bridge system 100. It sets up and maintains SIP signaling between endpoints and the transcription engine.

### Audio Bridging & SIP Call Mapping

In an example embodiment, the audio bridge system supports advanced SIP call mapping and audio capture functionality tailored for transcription, recording, and media management. The system enables distinct audio stream capture for each leg of a SIP-based conference call, supporting a variety of operational use cases.

The system supports three primary types of bridged call audio capture: primary (A-end) audio, sequence (B-end) audio, and mixed Audio.

Primary (A-end) audio captures media exclusively from the A-end participant of the SIP session. This typically corresponds to the originating side of the call and is associated with a virtual ID of 20000123456.

Sequence (B-end) audio captures media exclusively from the B-end participant of the SIP session. This represents the receiving side of the call and is associated with a virtual ID of 30000123456.

Mixed Audio captures a unified audio stream that includes media from both the A-end and B-end, as well as any dynamic legs. Dynamic legs refer to SIP or TDM connections established on demand-such as those created for overflow monitoring, ad hoc participants, or transcription support-which may not be statically provisioned prior to the call.

In some embodiments, all three audio stream types can be delivered concurrently to a transcription engine. This allows the system to process audio independently from the A-end and B-end participants, as well as the combined stream, enabling more granular transcription and enhanced error correction.

Each call session is associated with a set of identifiers (also referred to as configuration identifiers) used to distinguish and manage the various legs and services involved in the conference. These include:
Conference ID: 90000123456-Identifies the overall bridged session.
Primary Endpoint (A-end): 20000123456-Represents the virtual ID assigned to the originating participant, typically within the A-end system.
Sequence Endpoint (B-end): 30000123456-Represents the virtual ID assigned to the terminating participant, typically within the B-end system.

Each virtual ID is linked to a specific CNXVID (connection ID), which is used by the system to manage SIP signaling, route media streams, and apply services such as transcription or recording. These identifiers are programmatically assigned and serve as unique references within the larger conferencing or telephony system.

To establish call legs between participants, SIP INVITE messages are constructed using the virtual IDs in the header fields. For example, a SIP INVITE may be generated with a “From” header of 20000123456 and a “To” header of 30000123456. This message originates from the A-end system and targets the B-end system.

A reciprocal SIP INVITE can also be generated with a “From” header of 30000123456 and a “To” header of 20000123456, thereby initiating a call leg from the B-end to the A-end.

These signaling paths are visually depicted in FIG. 1 using dashed lines to represent the SIP message flows between endpoints. Each path corresponds to a distinct call leg that may be independently routed, monitored, or recorded within the audio bridge system.

### Bridging Initiation and Call Setup

To initiate a bridged call, the system receives a request—typically via an external controller or API—that specifies the conference number (i.e., the source of audio), a caller ID and a called ID (each identified using unique connection identifiers), the desired bridge type, and whether the bridge should be established or removed.

The bridge type can be primary, sequence, or mixed, each indicating which audio stream(s) are to be captured or mirrored. A primary-type bridge captures audio exclusively from the A-end leg of the call (i.e., the originating participant). A sequence-type bridge captures audio from the B-end leg (i.e., the terminating participant). A mixed-type bridge captures a composite audio stream that includes media from both the A-end and B-end participants, as well as from any dynamic legs that may be added to the session, such as for overflow monitoring, ad hoc participants, or transcription services.

Upon receiving a valid request, the system selects the appropriate audio stream based on the specified bridge type. It then uses a default SIP trunk configured for the node to place the call. If no default trunk is configured, the system uses the only available SIP trunk. Example API requests are implemented as RESTful POST calls to the audio bridge system API, specifying both the service line number and the destination to configure the desired bridge type.

### Audio Capture Logic

Depending on the specified bridge type, the system performs selective media capture: Primary-only bridging captures only SIP audio from the A-end legs. Sequence-only bridging captures only SIP audio from the B-end legs.

Mixed bridging aggregates audio from all legs (including SIP and TDM) and produces a unified audio stream.

In an example implementation, dynamic legs are excluded unless explicitly required for mixed bridging. In this example, the audio bridge restricts inclusion to legs that are actively participating in the call.

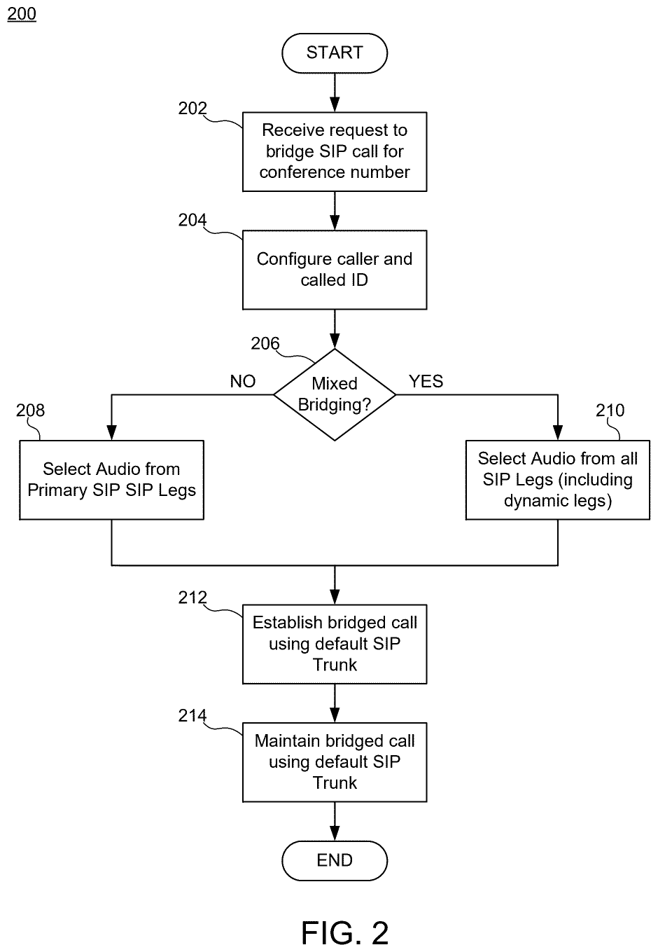

FIG. 2 is a flowchart depicting a bridging procedure 200 for bridging SIP calls in an audio bridge system, according to an example embodiment. The process begins at step 202 by receiving a request to bridge a SIP call for a specific conference number.

At step 204, upon receiving the request, the system configures the caller and called ID for the bridged call. The system then determines at step 206 whether mixed bridging is required.

If a determination is made at step 206 that mixed bridging is not required, at step 208, the system selects audio from primary SIP legs (excluding dynamic legs). If a determination is made at step 206 that mixed bridging is required, at step 210 the system selects audio from all SIP legs, including dynamic legs.

In turn, at step 212, the system establishes the bridged call using a default SIP trunk configured in the node. If no default SIP trunk is configured, the system selects a unique available SIP trunk.

At step 214, once established, the system maintains the bridged call using the default SIP trunk. The bridged call remains active until explicitly terminated or a failover event occurs requiring transition to a secondary node.

### Call Continuity and High Availability

In some embodiments, bridged calls are not terminated on RTP/RTCP timeouts, providing resilience to transient network issues. If a bridged call is not established immediately, the system retries auto-connect attempts for a predetermined time, e.g., up to 60 seconds. In some embodiments, the system retries auto-connect attempts a predetermined number of times. The retry attempts, whether based on time or number of retries are sometimes referred to generally as a retry limit.

In the event of call disconnection (e.g., far-end hang-up), automatic reconnection is triggered. In HA deployments, if a primary node fails, the secondary node automatically assumes responsibility for bridging the call, provided at least one SIP leg is connected to the conference.

### Resource Management and Monitoring

In some embodiments, the bridging service minimizes disruption. In an example implementation, this is accomplished by performing bridging operations that are non-intrusive, meaning that neither the original conferences nor call configurations are altered. In addition, bridged calls can be independently terminated on demand without impacting the original conference.

For monitoring, the number of enabled and connected bridged ports can be queried via CLI. Existing tools (e.g., asterisk-rx “sip show channels”) can be used to count active channels, excluding dynamic or ephemeral lines.

In some embodiments, the system does not use dynamic SIP ports for bridged audio, thereby preserving the integrity of call monitoring statistics.

In some embodiment, the system provides specific command-line interfaces for monitoring bridged call operations:
1. A command to display the number of enabled Bridged ports
2. A command to display the number of connected Bridged ports
3. A command to display the number of connected private wires (excluding dynamic/local lines), implemented using, e.g., the command: “asterisk-rx ‘sip show channels’ | grep-c \ [a, u\] law”

### Codec Support and Media Negotiation

In an example embodiment, when initiating a bridged call, the system includes all configured codecs (e.g., G.711 PCM) in the Session Description Protocol (SDP) of the call invite. This enables compatibility with the widest range of far-end endpoints and SIP trunks.

### Universal Availability

In some embodiments, bridging functionality is available on all nodes. This allows any node with access to the relevant SIP or TDM legs to perform bridging operations autonomously. To support this distributed bridging capability, the system exposes application programming interface (API) endpoints that facilitate the configuration and control of bridged call services. These API endpoints support automation and integration with external systems, such as management portals, allowing for dynamic control of audio bridging behavior across a distributed architecture.

In an example implementation, a conference-level bridging endpoint, e.g., /absocket/service_line_conf, is used for managing audio bridging at the conference scope. This endpoint is invoked when the system is requested to establish a bridge that spans all conference participants, capturing the complete audio mix for the entire session. For example, when a “Mixed” bridge type is specified in the API request, the system uses the conference-level bridging endpoint to initiate a service that connects to a conference bridge and extracts the full audio stream for transcription, monitoring, or recording purposes. The payload sent to this endpoint may include parameters such as the conference identifier, a destination URI for the bridged stream, and metadata indicating service intent (e.g., add or remove).

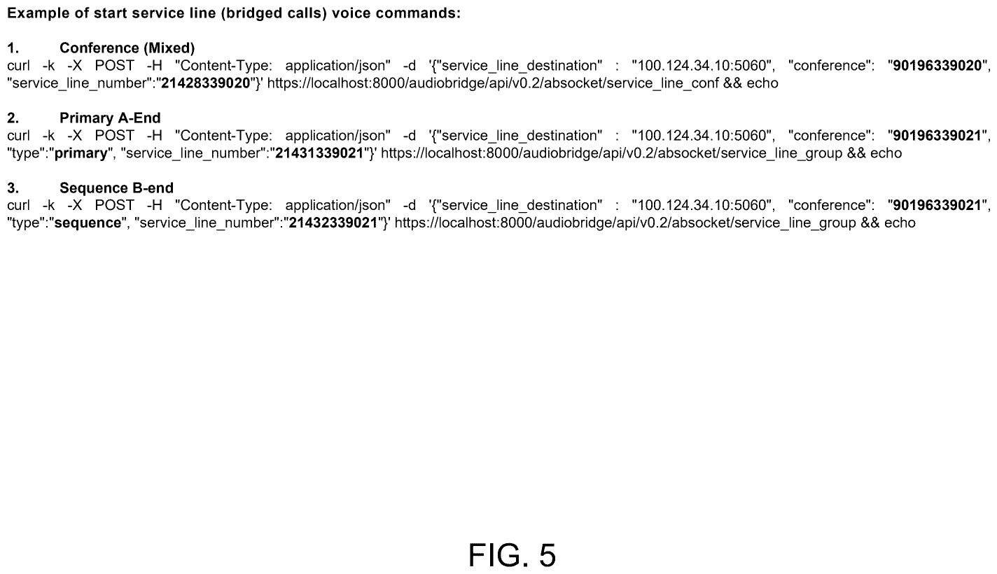

FIG. 5 illustrates example start service line (bridged calls) voice commands, according to an example embodiment.

Another API endpoint, referred to as the participant-level bridging endpoint, e.g., /absocket/service_line_group, is used for managing stream-level bridging in scenarios where the focus is on one leg of a call-typically either the A-end or B-end. This endpoint is suited for “Primary” or “Sequence” bridge types, in which the system is instructed to extract audio from a specific participant leg. For instance, if a bridge is needed to capture only the A-end (e.g., for compliance monitoring of a trader's communication device), the system invokes the participant-level bridging endpoint with a payload that identifies the caller's CNXVID and UCN, along with the bridge type and the target SIP trunk for routing the audio.

Both the conference-level bridging endpoint and the participant-level bridging endpoint support service activation and deactivation operations. Upon receiving a valid request, the system processes the command, updates internal service state, and responds with an acknowledgment indicating success or failure. This modular and API-driven architecture enables flexible, real-time control of bridging behavior across all nodes in the production environment, supporting universal availability and high reliability.

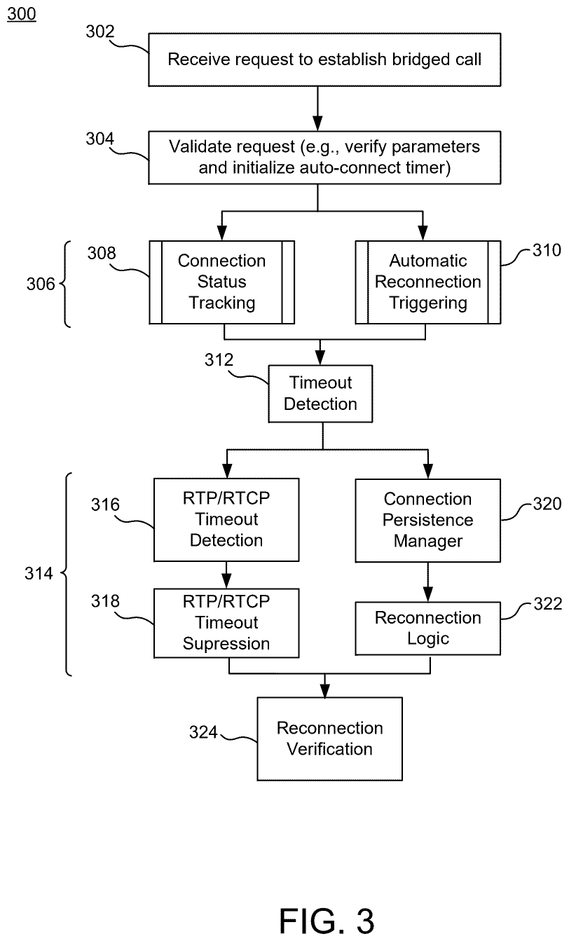

FIG. 3 illustrates an auto-connect architecture 300 for managing connection attempts and reconnection logic in bridged calls, according to an example embodiment. The diagram depicts the system's continuous connection management capabilities that provides call persistence and reliability. The process begins with bridged call initiation 302, where the system receives a request to establish a bridged call and selects an appropriate SIP trunk. Initial connection validation 304 verifies the request parameters and initializes an auto-connect window timer for a predetermined amount of time. In an example embodiment, the auto-connect window timer is a 60-second auto-connect window timer. In some embodiments, the auto-connect window timer is configured to align with a standardized connection management interval used across all nodes in the system.

A connection state management 306 continuously monitors active connections through multiple checkpoints. In an example implementation, connection status tracking 308 maintains real-time state information, while a disconnection detection 310 identifies connection failures. If a timeout is detected, as shown by timeout detection 312, automatic reconnection triggering initiates the recovery process.

In some embodiments, timeout handling 314 implements specialized logic to maintain connection persistence. An RTP/RTCP timeout detector 316 monitors protocol timeouts, while a timeout suppressor 318 prevents unwanted disconnections. A connection persistence manager 320 provides continuous service availability despite protocol timeout conditions.

In turn, reconnection logic 322 implements a continuous connection attempt loop within the 60-second window. When far-end disconnection is detected, the system automatically initiates reconnection attempts. In turn, a connection verifier 324 confirms successful reestablishment of bridged calls. This process enables bridged calls to continuously try to connect if not established and automatically reconnect in case of disconnection while maintaining persistent connections that do not disconnect on RTP/RTCP timeout.

### Computing Environment

FIG. 4 discloses a computing environment 400 in which aspects of the present disclosure may be implemented. A computing environment 400 is a set of one or more virtual or physical computers (410) that individually or in cooperation achieve tasks, such as implementing one or more aspects described herein. The computers (410) have components that cooperate to cause output based on input. Example computers (410) include desktops, servers, mobile devices (e.g., smart phones and laptops), wearables, virtual reality devices, augmented reality devices, expanded reality devices, spatial computing devices, virtualized devices, other computers, or combinations thereof. In particular example implementations, the computing environment 400 includes at least one physical computer.

The computing environment 400 may specifically be used to implement one or more aspects described herein. In some examples, one or more of the computers (410) may be implemented as a user device, such as mobile device and others of the computers (410) may be used to implement aspects of a machine learning framework useable to train and deploy models exposed to the mobile device or provide other functionality, such as through exposed application programming interfaces.

The computing environment 400 can be arranged in any of a variety of ways. The computers (410) can be local to or remote from other computers (410) of the computing environment 400. The computing environment 400 can include computers (410) arranged according to client-server models, peer-to-peer models, edge computing models, other models, or combinations thereof.

In many examples, the computers (410) are communicatively coupled with devices internal or external to the computing environment (400) via a network (402). The network (402) is a set of devices that facilitate communication from a sender to a destination, such as by implementing communication protocols. Example networks (402) include local area networks, wide area networks, intranets, or the Internet.

In some implementations, computers (410) can be general-purpose computing devices (e.g., consumer computing devices). In some instances, via hardware or software configuration, computers (410) can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use. Such relatively low powered device may nonetheless be specially configured for such inference tasks so that it performs inference faster or more efficiently than a standard desktop or laptop computer.

Many example computers (410) include a processor set (412), a memory set (414), and an interface set 418. Such components can be virtual, physical, or combinations thereof.

The processor set (412) is a set of one or more processors. Processors are components that execute instructions, such as instructions that obtain data, process the data, and provide output based on the processing. The processor set (412) often (collectively or individually) obtain instructions and data stored by the memory set (414). The processors of the processor set (412) can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the processor set (412) includes at least one physical processor implemented as an electrical circuit. Example providers or designers of processors (412) include INTEL, AMD, QUALCOMM, TEXAS INSTRUMENTS, and APPLE.

The memory set (414) is a collection of components configured to store instructions (416) and data for later retrieval and use. The instructions (416) can, when executed by one or more processors of processor set (412), cause execution of one or more operations that implement aspects described herein. In many examples, the memory (414) is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, the memory set (414) can include transitory memory that stores information encoded in transient signals.

The interface set (418) is a set of one or more components that facilitate receiving input from and providing output to something external to the computer (410), such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display). The interfaces set (418) can include one or more components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, or other protocols). One or more of the one or more interfaces (418) can facilitate connection of the computing environment 400 to a network (490).

The computers (410) can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method for bridging a SIP call from a specific conference number in an audio bridge system, comprising:
receiving a request to bridge a SIP call from a specific conference number;
configuring caller and called ID for the bridged call;
selecting audio from either all primary SIP legs excluding dynamic legs, or all sequence SIP legs excluding dynamic legs, or mixed audio of all primary and sequence SIP legs including dynamic legs; and
establishing the bridged call using a default SIP trunk configured in a node, or selecting a unique SIP trunk if no default is configured.

2. The method of claim 1, wherein the conference includes SIP legs, further comprising:
including SIP audio in the mixed audio of the bridged call; and
including only audio of the SIP legs in the bridged calls at an A-end and a B-end.

3. The method of claim 1, wherein the conference includes TDM legs, further comprising:
including TDM audio in the mixed audio of the bridged call; and
including only audio of the SIP legs in the bridged calls at an A-end and a B-end.

4. The method of claim 1, wherein the bridged calls can be triggered simultaneously for the same conference.

5. The method of claim 1, wherein the bridged calls are triggered only if there is at least one participant leg connected, and the type of bridged call is determined based on the type of connected leg.

6. The method of claim 1, wherein the bridged calls continuously try to connect if not established within a specified time period.

7. The method of claim 1, wherein the bridged calls automatically reconnect in case of disconnection.

8. The method of claim 1, wherein the bridged calls do not disconnect on RTP/RTCP timeout.

9. The method of claim 1, wherein the bridged calls are established in the secondary nodes of a high availability pair if the primary node fails.

10. The method of claim 1, wherein the bridged calls can be dropped separately on demand.

11. The method of claim 1, wherein the SDP of the bridged call includes all the codecs configured in a bridge where it is triggered.

12. The method of claim 1, wherein bridging a call does not impact conferences, calls, or original configuration.

13. The method of claim 1, wherein the bridged call feature is available on all nodes in production.

14. A bridge system comprising:
a processor configured to execute instructions for bridging a SIP call from a specific conference number based on configurable caller and called ID, and selecting audio from either all primary SIP legs excluding dynamic legs, or all sequence SIP legs excluding dynamic legs, or mixed audio of all primary and sequence SIP legs including dynamic legs;
a memory coupled to the processor, the memory storing instructions and data for executing the bridging of the SIP call; and
a network interface configured to receive the request for bridging the SIP call and establish the bridged call using a default SIP Trunk configured in a node or selecting a unique SIP Trunk if no default is configured.

15. A non-transitory computer-readable storage medium storing instructions for bridging a SIP call from a specific conference number in an audio bridge system, the instructions, when executed by a processor, cause the processor to perform the steps of:
receiving a request to bridge a SIP call from a specific conference number;
configuring caller and called ID for the bridged call;
selecting audio from either all primary SIP legs excluding dynamic legs, or all sequence SIP legs excluding dynamic legs, or mixed audio of all primary and sequence SIP legs including dynamic legs; and
establishing the bridged call using a default SIP Trunk configured in a node, or selecting a unique SIP trunk if no default is configured.
